(19) United States
(12) Patent Application Publication
(10) Pub. No.: US 2005/0235706 A1
(43) Pub. Date: Oct. 27, 2005

(54) Locking device with dual locking mechanisms

(75) Inventors: Renny Tse-Haw Ling, Jhonghe City (TW); Yung-Li Kuo, Jhonghe City (TW)

Correspondence Address: Ladas & Parry, 26 West 61 Street, New York, NY, 10023, US

(73) Assignee: SINOX COMPANY LTD.

(21) Appl. No.: 11/001,618

(22) Filed: Dec. 1, 2004

(30) Foreign Application Priority Data
Apr. 21, 2004 (TW) 093111088

(51) Int. Cl. E05B 37/02

(52) U.S. Cl. 70/29; 70/284; 70/285

(57) ABSTRACT

A locking device with dual locking mechanisms, comprising a lock body and a locking member having two locking arms. The two locking arms can engage with the lock body separately to form an enclosed loop with the lock body to lock an article. Each of the two locking arms can be moved respect to the lock body or each other to form a gap in the enclosed loop. Two locking mechanisms are disposed inside the lock body and can be operated separately to lock the respective locking arms, thereby the locking device can be locked or unlocked by operating each of the locking mechanisms.

### BACKGROUND OF THE INVENTION

1. Field of the Invention

The present invention relates to a locking device, such as a padlock or a zipper-lock, with dual locking mechanisms, especially the locking device with two separately operatable locking mechanisms. The locking device can be inter-connected to a locking member or an external locking member to lock an article. The present application claims priority based on ROC (Taiwan) Patent Application No. 093111088 and is related to a contemporaneously filed application also entitled “Locking Device with Dual Locking Mechanisms” with the same assignee and inventors.

2. Description of the Related Art

Lock is a well known product and can be widely used to secure articles with obvious or potential security concerns. For example, a lock can be attached to a luggage case to lock its zipper and to prevent the zipper from being unzipped by any intentional third party.

The operation of locking and unlocking a lock mainly depends on the locking mechanism it contains. Common locking mechanisms include “key locking mechanism,” which is operated by a key and “combination locking mechanism,” in which a lock can be unlocked when a set of combination wheels is rotated and aligned to a correct “password” or locked when the set of combination wheels is rotated and aligned to any incorrect number combination.

For a key locking mechanism, a lock has to be unlocked by a specific key which is not required for a lock with a combination locking mechanism. On the contrary, a lock with a combination locking mechanism can be unlocked when a correct “password” is aligned or locked when an incorrect number combination is produced. In term of operation, each of the both locking mechanisms has a reciprocal advantage for the other, since the key locking mechanisms can safeguard the “password” of the combination locking mechanism from being guessed correctly, while a combination locking mechanism can save the hassle of keeping a key. Therefore, a user can choose a lock with any type of locking mechanism according to his/her needs.

However, in the following scenarios, potential needs for a locking device with multiple locking mechanisms by a user arise, for example:
1. For a locking device with key locking mechanism, a spare key or a new key cut is needed when the key of the locking device is lost.
2. As for the United States, which has been under terrorists' attack, for security reasons, airport security staff will rigorously inspect passengers and their luggage. Sometimes it is necessary for them to open the luggage and make thorough inspection without passengers' consent. For the safety of their belongings, most passengers will secure their luggage by attaching a lock to the zipper of the luggage or use a luggage with a luggage latch. Therefore, when it is necessary for the airport security staff to inspect contents in the luggage, they will have to break the lock and thus cause irreversible damages.

U.S. Pat. No. 6,539,761 (referred to as '761 patent herein) has disclosed a locking device with two different locking mechanisms, which is characterised in that the two locking mechanisms can be operated to engage or disengage a single shackle separately. Compared with conventional locks with only one locking mechanism, it can overcome the above defects when in use.

The '761 patent is characterised in that one end of the shackle comprises “two-step” engaging configuration, in which two locking mechanisms engage the corresponding recesses disposed at one end of the shackle separately, thereby the shackle can be locked to a lock body and form an enclosed loop with the lock body to lock an article, or the shackle can be pulled upwards and thus unlocked to form a gap in the enclosed loop.

However, for the one end of the shackle to be locked by two locking mechanisms separately, the above two-step engaging configuration is required at one end of the shackle. In addition, engaging portions at corresponding positions of the shackle end to be engaged by the two locking mechanisms are necessary. Moreover, the shackle has to be a rigid body so two ends of the shackle can be moved together such that the movement of the free end is consistent with the locked end with respect to the lock body.

From the above, although a locking device with two locking mechanisms has been disclosed, as in the '761 patent, the configuration of two locking mechanisms engaging only one end of the shackle is complicated, and the shackle is restricted to a rigid body.

### SUMMARY OF THE INVENTION

It is an object of the present invention to provide a locking device with two locking mechanisms, in which, unlike the '761 patent, two locking mechanisms are engaged with different inserting ends of a locking member separately. In other words, each locking mechanism is locked to the corresponding inserting end of the locking member.

It is the other object of the present invention to provide a locking device with more compact configuration and a locking member which is not restricted to a rigid body.

According to the locking device of the present invention provides the following advantages:
1. Two locking mechanisms are engaged with the corresponding ends of the locking member, which in turn simplifies the configuration between the locking mechanisms and the locking member and provides more flexible overall configuration.
2. The locking member is not restricted to a rigid body, since the locking member engage with two locking mechanisms at corresponding ends.

Other objects, advantages and novel features of the present invention will be drawn from the following detailed description of preferred embodiments of the present invention with the accompanying drawings, in which:

### DESCRIPTIONS OF THE DRAWINGS

FIG. 1 illustrates the first preferred embodiment according to the present invention showing the locking device is locked;

FIG. 2 illustrates a sectional view of the first embodiment showing the locking device is locked;

FIG. 3 illustrates a sectional view of the first embodiment showing the locking device is unlocked at the one end;

FIG. 4 illustrates a sectional view of the first embodiment showing the locking device is unlocked at the other end;

FIG. 5 illustrates a coupling mechanism between a lock body and a locking mechanism in the first preferred embodiment;

FIG. 6 illustrates another coupling mechanism between the lock body and the locking mechanism in the first preferred embodiment; and

FIG. 7 illustrates the second preferred embodiment according to the present invention.

### DETAILED DESCRIPTION OF THE INVENTION

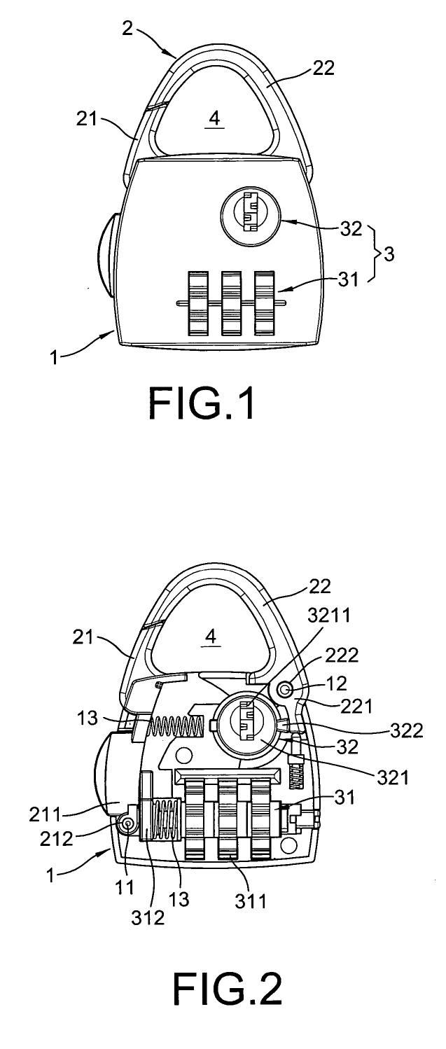

FIG. 1 illustrates the first preferred embodiment of a locking device according to the present invention. The locking device comprises a lock body 1, a locking member 2 and locking mechanism set 3 disposed in the lock body 1. Locking mechanism set 3 further comprises a first locking mechanism 31 and a second locking mechanism 32.

Now referring to FIG. 2, the locking member 2 has a first arm 21 and a second arm 22, whose respective first and second ends 211, 221 are pivotally coupled to the lock body 1, thereby the first and the seconds arms form an enclosed loop 4 with the lock body 1. The movement of each of the first and the second arms can be restricted separately by the corresponding first locking mechanism 31 and the second locking mechanism 32.

In general, the first and the second locking mechanisms 31, 32 can be different from each other, for example, they can be a combination locking mechanism, a key locking mechanism or any other conventional locking mechanism which can be operated differently. Both of the first and the second locking mechanisms 31, 32 can also be the same, such as a combination locking mechanism or a key locking mechanism. It should be noted that locking mechanism set 3 is not necessarily restricted to only combination locking mechanism or key locking mechanism, as long as the first and the second locking mechanisms 31, 32 can be operated to restrict the movement of the first and the second arms 21, 22 of the locking member 2, thereby the locking member 2 can be locked and secured to the lock body 1.

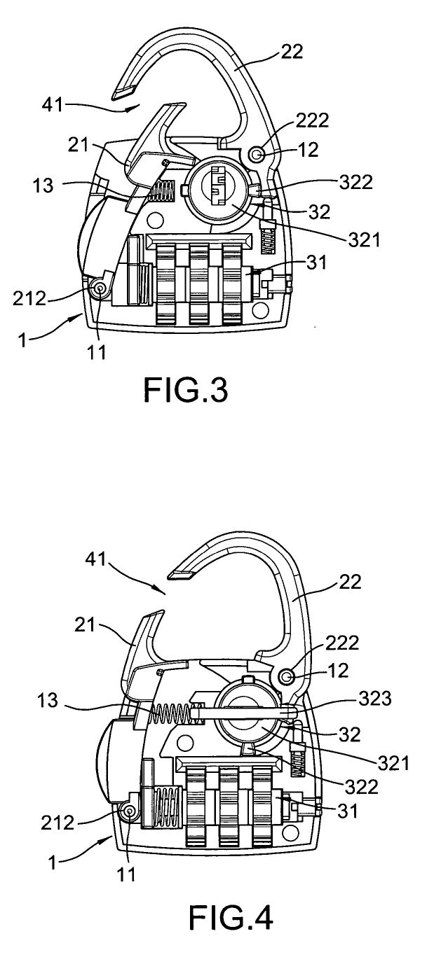

Referring to FIGS. 3 and 4, which shows a sectional view of the locking device according to the first embodiment. A first hole 212 is disposed at the first end 211 of the first arm 21 and a second hole is disposed at the second end 221 of the second arm 22. The first and the second arms 21, 22 are pivotally coupled to the lock body 1 by a first pin 11 and a second pin 12 and can be rotated around the first and the second pins 11, 12, thereby first and the second arms 21, 22 can be moved and rotated with respect to the lock body 1. The first and the second arms 21, 22 can be rotated to a contact position to form the enclosed loop 4 with the lock body 1. Both of the first and the second arms 21, 22 can be retained at the contact position by a force provided by a return spring 13. Each of the first and the second arms 21, 22 can be moved/rotated with respect to the lock body 1 to open a gap 41 in the enclosed loop 4 while the other of the first and the second arms 21, 22 is stationary with respect to the lock body 1.

As described above, the first and the second locking mechanisms 31, 32 can be operated differently. In this embodiment, the first locking mechanism 31 is a combination locking mechanism while the second locking mechanism 32 is a key locking mechanism. The first locking mechanism 31 comprises a return spring 13, a plurality of combination wheels 311 and a core rod 312, whose movement can be restricted or freed by dialling the combination wheels 311, thereby the first arm 21, which is operatively coupled to the core rod 312, can be rotated to actuate the core rod 312 or be fixed to a locking position. The second locking mechanism 32 comprised a key hole 3211, a cylinder 321 and a locking tongue 322, which is disposed at an outer edge of the cylinder 321 and is actuated simultaneously with the cylinder 321. When a matching key 323 is inserted into the key hole 3211, the cylinder 321 can be rotated by the key 323 such that the locking tongue 322 can be moved from a locking position of the second arm 22 to an unlocking position thereof, where the second arm 22 is freed to move.

FIG. 3 illustrates that the first locking mechanism 31 is operated to a state where the first arm 21 can be moved with respect to the lock body 1. The first arm 21 can be pushed and rotated towards the lock body 1 to open an enlarged gap 41 with respect to the second arm 22. Similarly, FIG. 4 illustrates that the second locking mechanism 32 is operated to a position such that the locking tongue 322 is moved to unlock the second arm 22, which can subsequently be pulled and rotated to open an enlarged gap 41 with respect to the first arm 21.

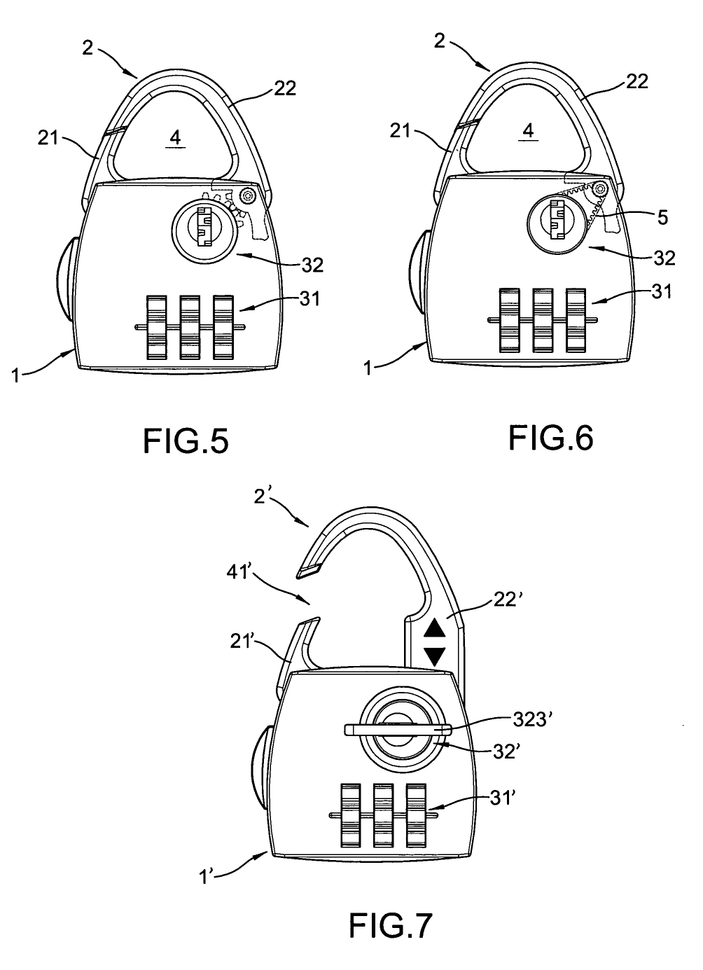

It should be noted that the first and the second locking mechanisms 31, 32 are not restricted to the types shown in the previous drawings, and the way to lock or unlock the locking member 2 can also be achieved directly or indirectly. As long as either or both of locking mechanisms 31, 32 can be rotatably operated by a key locking mechanism, either or both of the first or the second arms can be operatively coupled to the respective locking mechanism 31, 32. For example, the second arm 22 rotatably engages the second locking mechanism 32 directly in FIG. 5 while in FIG. 6, the second arm 22 is rotatably coupled to the second locking mechanism 32 via a transmission part 5, which can be a belt, a chain or a connecting rod. Similarly, the first arm 21 cab be adapted to rotatably engage the first locking mechanism 31 directly, or the first arm 21 can be adapted to be rotatably coupled to the first locking mechanism 31 via a transmission part 5 (not shown in figures), which can be a belt, a chain or a connecting rod.

As shown in FIG. 7, it demonstrates that the movement between the lock body 1′ and the locking member 2′ is not restricted to rotation, and the actuation and coupling between the locking member 2′ and the locking mechanisms 31′, 32′ can also be varied. The first and the second arms 21′, 22′ can be slidably coupled the lock body 1′. Also, one of the first and the second arms can be slidably coupled to the lock body 1′ while the other can be rotatably coupled to the lock body 1′.

From the above descriptions, it is apparent that the present invention provides a locking device with dual locking mechanisms and has more compact and flexible configuration over the prior art. While the invention has been described in terms of several preferred embodiments, those skilled in the art will recognise that the invention can still be practiced with modifications, within the spirit and scope of the appended claims.

1. A locking device with dual locking mechanisms, comprising:
a lock body;
a locking member, comprising a first arm and a second arm, each of the first and the second arms being moveably coupled to the lock body separately, thereby the first and the second arms can be maintained at a position to form an enclosed loop with the lock body and open a gap in the enclosed loop while at least one of the first and the second arms is moved with respect to the lock body;
a first locking mechanism, operatively disposed in the locking body restricting movement of the first arm with respect to the lock body; and
a second locking mechanism, operatively disposed in the locking body restricting movement of the second arm with respect to the lock body.

2. The locking device according to claim 1, wherein one of the first and the second locking mechanisms is different from the other.

3. The locking device according to claim 1, wherein both of the first and the second locking mechanisms are the same.

4. The locking device according to claim 1, wherein the first locking mechanism is a rotatably operated locking mechanism and is operatively coupled to the first arm.

5. The locking device according to claim 4, wherein the first locking mechanism is moveably coupled to the first arm via a transmission part.

6. The locking device according to claim 1, wherein the first locking mechanism is a combination locking mechanism.

7. The locking device according to claim 1, wherein the second locking mechanism is a rotatably operated locking mechanism and is operatively coupled to the second arm.

8. The locking device according to claim 7, wherein the second locking mechanism is moveably coupled to the second arm via a transmission part

9. The locking device according to claim 1, wherein the second locking mechanism is a key locking mechanism.

10. The locking device according to claim 1, wherein the first arm can be rotated with respect to the lock body.

11. The locking device according to claim 1, wherein the first arm can be slid with respect to the lock body.

12. The locking device according to claim 1, wherein the second arm can be rotated with respect to the lock body.

13. The locking device according to claim 1, wherein the second arm can be slid with respect to the lock body.

14. The locking device according to claim 5, wherein the transmission part is a belt.

15. The locking device according to claim 5, wherein the transmission part is a chain.

16. The locking device according to claim 5, wherein the transmission part is a connecting rod.

17. The locking device according to claim 8, wherein the transmission part is a belt.

18. The locking device according to claim 8, wherein the transmission part is a chain.

19. The locking device according to claim 8, wherein the transmission part is a connecting rod.
